(19) United States
(12) Patent Application Publication
(10) Pub. No.: US 2008/0237417 A1
(43) Pub. Date: Oct. 2, 2008

(54) Elevating mechanism for woodworking

(76) Inventor: Hsu Hsiu-Kwei Liu, Taichung (TW)

Correspondence Address: TROXELL LAW OFFICE PLLC, SUITE 1404, 5205 LEESBURG PIKE, FALLS CHURCH, VA, 22041, US

(21) Appl. No.: 11/730,352

(22) Filed: Mar. 30, 2007

(51) Int. Cl. F16M 11/24

(52) U.S. Cl. 248/188.4; 108/146; 108/147

(57) ABSTRACT

An elevating mechanism is mounted on a woodworking bench for adjusting a cutting depth of a milling cutter. In the elevating mechanism, two curved arms are pivotally turnably connected at proximal ends to and between two frame members. When it is desired to clamp or release the milling cutter via the two curved arms, a compression spring provided between two distal ends of the two curved arms allows the two curved arms to be pushed against or pulled from the milling cutter via an adjusting lever at reduced force.

### FIELD OF THE INVENTION

The present invention relates to an elevating mechanism for woodworking, and more particularly to an elevating mechanism for woodworking that allows an operator to clamp or release a milling cutter by operating an adjusting lever at reduced force.

### BACKGROUND OF THE INVENTION

There are various differently designed elevating mechanisms for mounting on a woodworking bench to adjust a vertical position and accordingly, a cutting depth of a milling cutter. FIG. 1 is a bottom view of a conventional elevating mechanism for woodworking most frequently seen in the market. As shown, this conventional elevating mechanism includes a top base 7, below which a one-piece metal locating plate having two curved clamping portions 1, 2 is mounted for clamping the milling cutter in place. As can be seen from FIG. 1, the two curved clamping portions 1, 2 of the one-piece metal locating plate are connected at respective free ends via a link 4. An adjusting lever 3 is pivotally turnably connected at a cam-shaped proximal end to an end of the link 4 connected to the curved clamping portion 2. Two cuts 11, 21 are provided near the free ends of the two curved clamping portions 1, 2, giving the two curved clamping portions 1, 2 a certain degree of elasticity. When the adjusting lever 3 is pivotally turned about the cam-shaped proximal end in a predetermined direction, the link 4 is moved to pull the two clamping portions 1, 2 inward at the same time. When the cam-shaped proximal end of the adjusting lever 3 is firmly pressed against the end of the link 4 connected to the clamping portion 2, a cutter holder 6 at the lower end of the milling cutter is firmly held in place by the two inward pulled clamping portions 1, 2.

With the above arrangements, an operator has to apply a large force to turn the adjusting lever, so as to pull the two curved clamping portions 1, 2 inward to firmly clamp the cutter holder 6 therebetween. Therefore, the conventional elevating mechanism for woodworking as shown in FIG. 1 is inconvenient for use.

### SUMMARY OF THE INVENTION

A primary object of the present invention is to provide an elevating mechanism for woodworking that allows an operator to clamp or release a milling cutter by operating an adjusting lever at reduced force.

To achieve the above and other objects, the elevating mechanism for woodworking according to the present invention includes two curved arms that are pivotally turnably connected at proximal ends to and between two frame members. When it is desired to clamp or release a milling cutter via the two curved arms, a compression spring located between two distal ends of the two curved arms allows the curved arms to be pushed against or pulled from the milling cutter via an adjusting lever at reduced force.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a bottom view of a conventional elevating mechanism for woodworking;

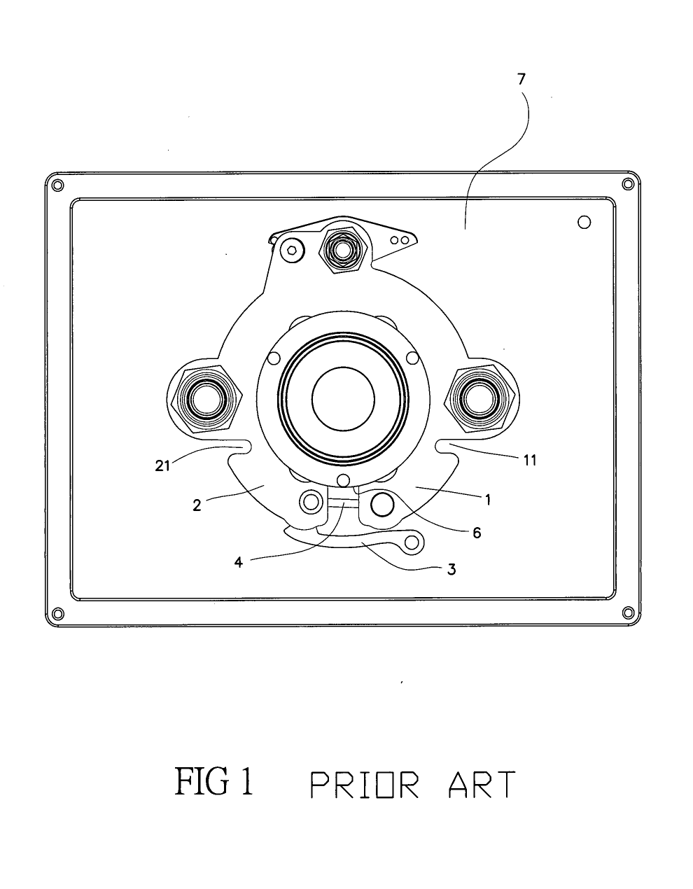

FIG. 2 is a bottom perspective view of an elevating mechanism for woodworking according to the present invention;

FIG. 3 is a side view of the elevating mechanism for woodworking according to the present invention; and

FIG. 4 is a bottom view of the elevating mechanism for woodworking of the present invention with an adjusting lever thereof turned to an inward position; and

FIG. 5 is another bottom view of the elevating mechanism for woodworking of the present invention with the adjusting lever located at an initial position.

### DETAILED DESCRIPTION OF THE PREFERRED EMBODIMENTS

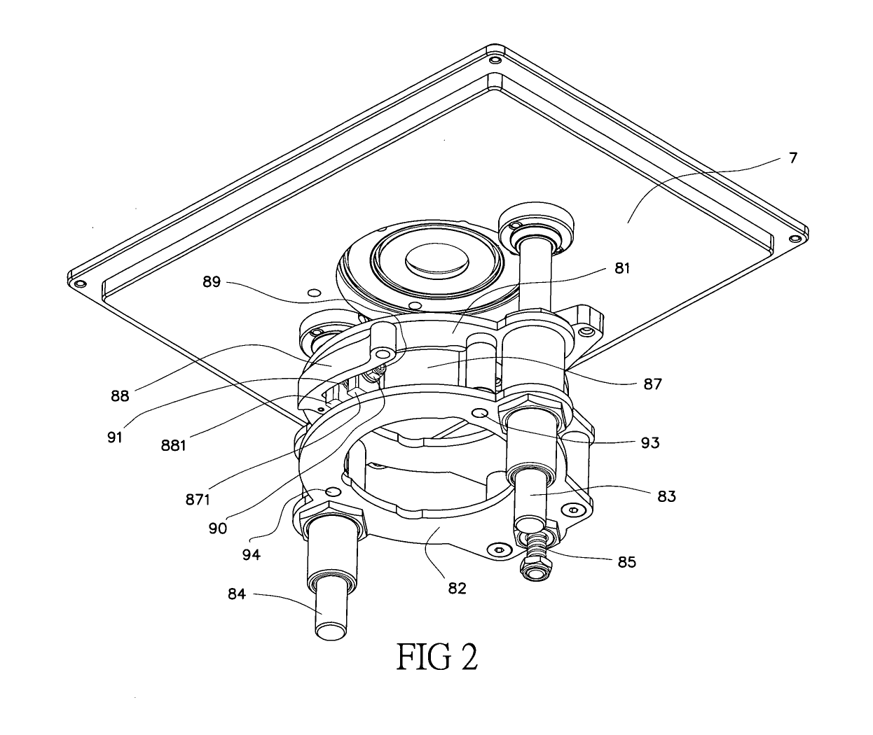

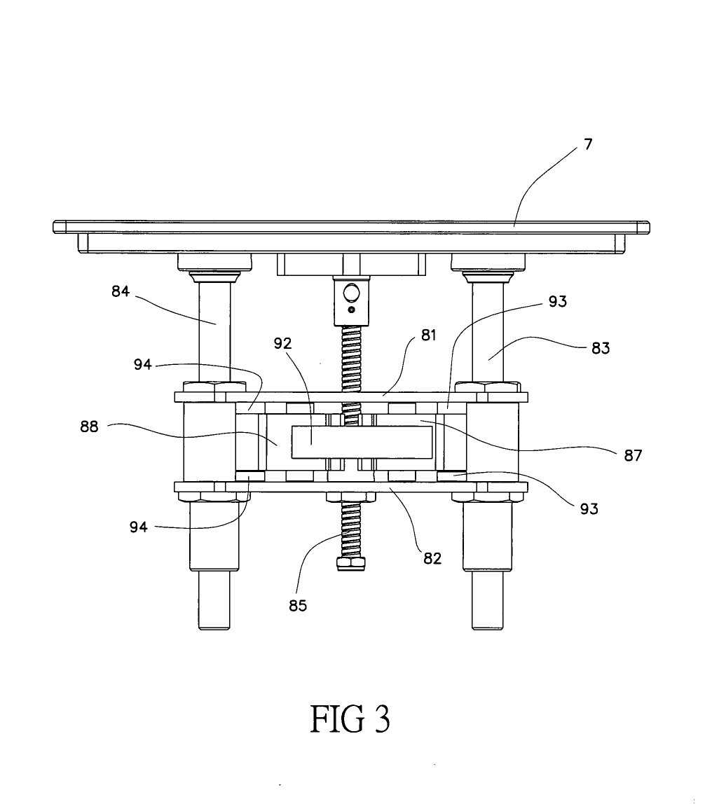

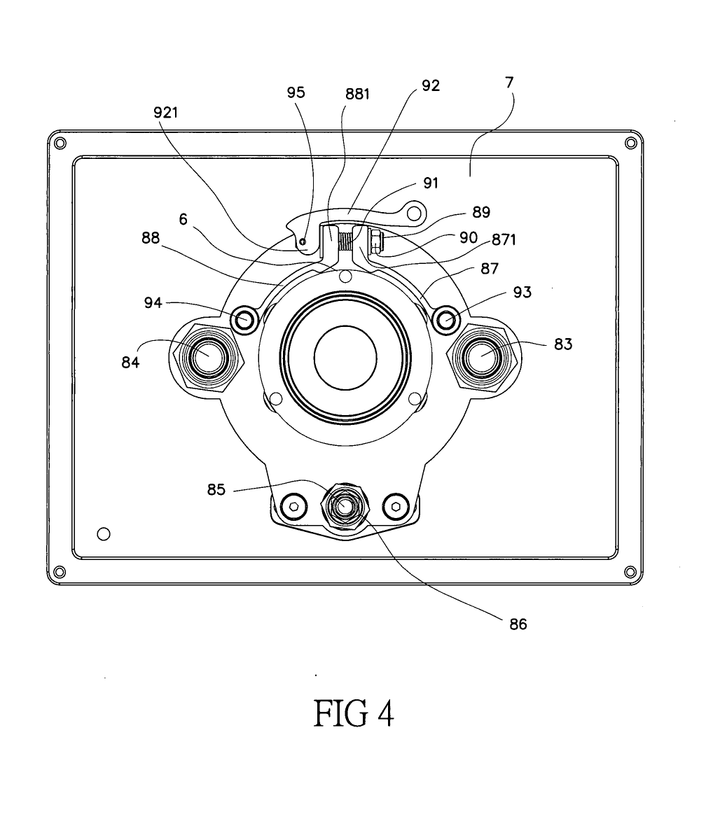

Please refer to FIGS. 2, 3, and 4 at the same time. An elevating mechanism for woodworking according to the present invention includes a top base 7, to an underside thereof two frame members 81 and 82, two supporting posts 83 and 84, and a screw rod 85 are assembled, such that when a hexagonal wrench (not shown) is extended into a threaded hole 86 (see FIG. 4) above the screw rod 85 and turned, the two frame members 81, 82 are brought to move upward or downward along the screw rod 85 and the supporting posts 83, 84. The elevating mechanism for woodworking according to the present invention is characterized in that a set of two curved arms 87 and 88, a bolt 89, a nut 90, a compression spring 91, and an adjusting lever 92 are provided between the two frame members 81 and 82.

The two curved arms 87, 88 have a proximal end each, that are screwed to and between the two frame members 81, 82 to form two pivot points 93, 94, respectively; and a distal end each, that are outward bent into a flat portion 871, 881, respectively. The bent flat portions 871, 881 are provided with a through hole each, via which a front end of the bolt 89 is sequentially extended across the two flat portions 871, 881. The compression spring 91 is put around the bolt 89 to locate between the two flat portions 871, 881. The nut 90 is screwed to a rear end of the bolt 89 to locate at an outer side of the flat portion 871 of the curved arm 87. The front end of the bolt 89 is connected via a pin 95 to and between two cam plates 921 forming a proximal end of the adjusting lever 92, so that the pin 95 serves as a pivot point, about which the adjusting lever 92 may be pivotally turned from an initial position to an inward position to cause the two curved arms 87, 88 to turn inward at the same time, as shown in FIG. 4.

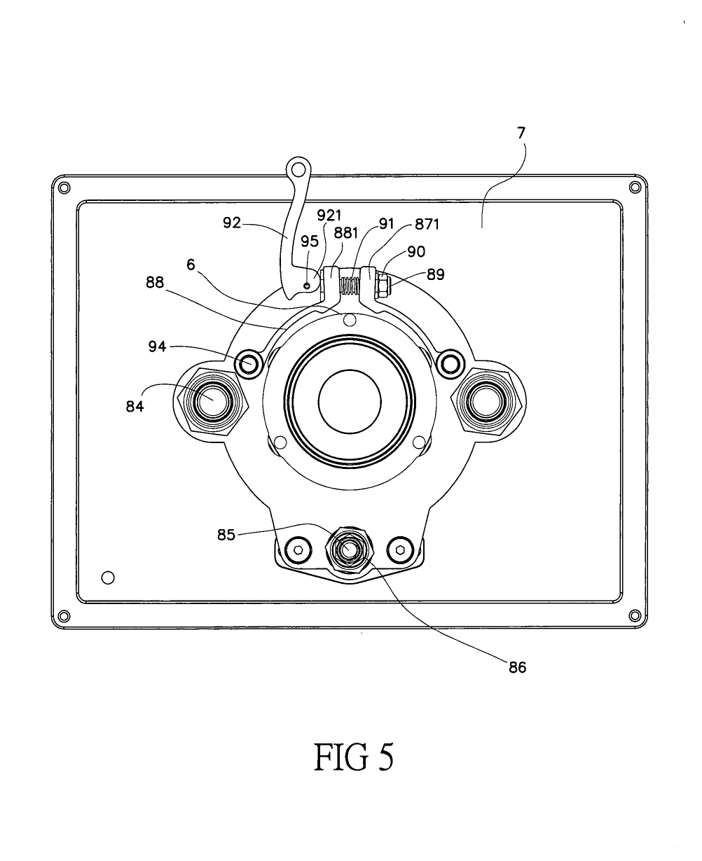

Please refer to FIG. 5, which is a bottom view of the present invention with the adjusting lever 95 located at an outward extended initial position. When it is desired to firmly clamp and hold a cutter holder 6 connected to a lower end of a milling cutter (not shown), simply inward turn the adjusting lever 92 about the pivot pin 95, as shown in FIG. 4, so that the two cam plates 921 at the proximal end of the adjusting lever 95 are rotated to press against and push the front end of the bolt 89 backward. At this point, the two curved arms 87, 88 are inward turned about the pivot points 93, 94 to thereby firmly hold the cutter holder 6 in place. With the compression spring 91 provided on the bolt 89 between the two flat portions 871, 881 of the curved arms 87, 88, the adjusting lever 92 may be elastically operated at reduced force to control the two curved arms 87, 88.

What is claimed is:

1. An elevating mechanism for woodworking, comprising a top base, two frame members, two supporting posts, and a screw rod; the elevating mechanism being characterized in that a set of two curved arms, a bolt, a nut, a compression spring, and an adjusting lever are mounted to and between the two frame members.

2. The elevating mechanism for woodworking as claimed in claim 1, wherein the two curved arms have a proximal end each, which are screwed to and between the two frame members to serve as two pivot points.

3. The elevating mechanism for woodworking as claimed in claim 2, wherein the two curved arms have a distal end each, which are bent into two flat portions.

4. The elevating mechanism for woodworking as claimed in claim 3, wherein the bent flat portions at the distal ends of the two curved arms are provided with a through hole each.

5. The elevating mechanism for woodworking as claimed in claim 1, wherein the bolt is extended at a front end across the through holes on the bent flat portions of the two curved arms.

6. The elevating mechanism for woodworking as claimed in claim 5, wherein the compression spring is put around the bolt to locate between the two bent flat portions of the two curved arms.

7. The elevating mechanism for woodworking as claimed in claim 6, wherein the nut is screwed to a rear end of the bolt when the bolt has been extended across the two flat portions.

8. The elevating mechanism for woodworking as claimed in claim 1, wherein the adjusting lever has a proximal end formed into two cam plates.

9. The elevating mechanism for woodworking as claimed in claim 6, wherein the front end of the bolt is connected to the two cam plates via a pin that serves as a pivot point.
